(19) United States
(12) Patent Application Publication
(10) Pub. No.: US 2023/0109011 A1
(43) Pub. Date: Apr. 6, 2023

(54) PLACING A DEVICE IN SECURE MODE

(71) Applicant: Hewlett-Packard Development Company, L.P., Spring, TX (US)

(72) Inventors: Russell Fredrickson, Vancouver, WA (US); Jefferson P. Ward, Vancouver, WA (US); Marvin Nelson, Boise, ID (US); Gary T. Brown, Boise, ID (US); Gary M. Nobel, San Diego, CA (US)

(21) Appl. No.: 17/493,069

(22) Filed: Oct. 4, 2021

(51) Int. Cl. G06F 21/74; G06F 21/76

(52) U.S. Cl. CPC G06F 21/74; G06F 21/76; G06F 2221/2105

(57) ABSTRACT

In some examples, an apparatus can include a memory resource and hardware logic to analyze a plurality of configuration settings associated with a non-volatile storage bit array controlling access to a hardware logic device. In response to detecting an inconsistency in the configuration settings during analysis, the hardware logic device can be placed in a most secure mode to resist a security threat.

### BACKGROUND

A computing device can be a mechanical or electrical device that transmits or modifies energy to perform or assist in the performance of human tasks. Examples include thin clients, personal computers (e.g., notebook, desktop, etc.), a controller, printing devices, laptop computers, mobile devices (e.g., e-readers, tablets, smartphones, etc.), internet-of-things (IoT) enabled devices, and gaming consoles, among others.

Hardware logic can include a sequence of operations performed by hardware and can be contained in electronic circuits of a computing device. A hardware logic device includes a device (e.g., a logic die, application-specific integrated circuit (ASIC), corresponding logic in another device, etc.) to perform the sequence of operations.

### BRIEF DESCRIPTION OF THE DRAWINGS

FIG. 1 illustrates a device to be placed in a secure mode according to an example;

FIG. 2 illustrates another device to be placed in a secure mode according to an example;

FIG. 3 illustrates yet another device to be placed in a secure mode according to an example; and

FIG. 4 illustrates a method for placing a device in a secure mode according to an example.

### DETAILED DESCRIPTION

A non-volatile storage array (e.g., a one-time programmable (OTP) array) may be used to configure security settings on embedded hardware logic such as an embedded application specific integrated circuit (ASIC)). The array may be read in a sequential manner (e.g., over time, not all at once) such that a temporal glitch may produce incorrect data and unlock protected debug features, which may be used for malicious purposes.

Some approaches to addressing security threats include the use of antivirus programs including computer programs to prevent, detect, and remove security threats such as malicious programs designed to disrupt, damage, and/or gain unauthorized access to a computing device. As used herein, the term computing device refers to an electronic system having a processing resource and a memory resource. Other approaches use firmware, which may be too slow to stop the attack via the protected debug features.

Yet other approaches to addressing security threats include detecting and determining malicious actors (e.g., computer programs) include utilizing antivirus programs to sense processes and stop or “kill” the process before the process can harm the computing device and/or a system of computing devices. However, such examples neither address temporal glitching of non-volatile storage arrays and/or configuration inconsistencies of particular portions of bits within the array.

In contrast, examples of the present disclosure can provide for a computing device and/or hardware logic to place the hardware logic into a most secure state if it is determined inconsistencies exist in a plurality of configuration settings. As used herein, a “most secure mode” is a mode or state in which a device and/or hardware logic is placed that determines who or what has access to the device and/or hardware logic. For instance, a most secure mode may allow only certain types of users to directly or indirectly access the device or associated secure processing resource and/or hardware logic, may process only particular types of data including classification levels, compartments and categories, and/or may dictate types of levels of users, their need-to-know access, and formal access approvals users may have. An example most secure mode may include a production configuration mode.

For example, a plurality of bits may be scattered across a non-volatile storage array (e.g., across various OTP words) to prevent a temporal glitch from unlocking hardware features. While OTP bits and arrays are used in examples herein, other non-volatile storage elements may be utilized. These bits may be blown during production and form a “production word”. Desired behavior may be for the scattered bits to be all 0 (debug) or all 1 (Production). All 0 may indicate allowing a read security configuration to stand, while all 1 may indicate the hardware logic device is in a production mode and that security settings should be properly configured for customer behaviors. Any other values may be deemed an inconsistency, forcing the hardware logic device into a “most secure mode” before firmware begins operations. The most secure mode can reduce security threats because a processing unit of an application of the device may not start until after analysis associated with the most secure mode decision is complete. Put another way, functional operations of the device are held in reset until the security analysis is complete. This can reduce leakage of early operations information via device security, reducing security threats.

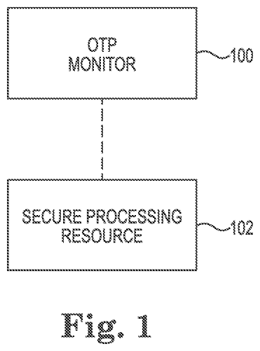

FIG. 1 illustrates a device 100 (e.g., a computing device, hardware logic device, etc.) to be placed in a secure mode according to an example. In some examples, the device 100 (e.g., referred to in FIG. 1 as an “OTP monitor”) can include a processing resource communicatively coupled to a memory resource and/or may be communicatively coupled to a secure processing resource 102. “Communicatively coupled,” as used herein, can include coupled via various wired and/or wireless connections between devices such that data can be transferred in various directions between the devices. The coupling may not be a direct connection, and in some examples can be an indirect connection. In some instances, the device 100 can include a hardware logic device that can be coupled to a memory resource, processing resource, or both.

As noted, the device 100 can be a computing device that can include components such as a processing resource. As used herein, the processing resource can include, but is not limited to, a central processing unit (CPU), an application specific integrated circuit (ASIC), a field programmable gate array (FPGA), a metal-programmable cell array (MPCA), a semiconductor-based microprocessor, or other combination of circuitry and/or logic to orchestrate execution of instructions. In other examples, the device can include instructions stored on a machine-readable medium (e.g., the memory resource, non-transitory computer-readable medium, etc.) and executable by the processing resource. In a specific example, the device 100 utilizes a non-transitory computer-readable medium storing instructions that, when executed, cause the processing resource to perform corresponding functions. In another specific example, the device 100 is a hardware Magic device to monitor for inconsistencies in a non-volatile storage array.

The secure processing resource 102 may be a computer-on-a-chip, a microprocessor, or other processing resource embedded in a packaging with a plurality of security measures, including physical security measures. The secure processing resource 102 may not output data or instructions in an environment where security cannot be maintained. The secure processing resource 102 may not have a network connection but can receive input and share output with the device 100.

When a computing device such as a printing device is developed, full access to processing resources such as the secure processing resource 102 and other components is allowed to create an effective computing device. As the computing device is tested and accessed by third parties, accesses can be changed to protect the processing resources and reduce security threats. Such protection may be provided using non-volatile storage bits, such as OTP fuse bits, among other. Example OTP bits may include, for instance, fused memory bits, electrically programmable fuse (eFuse) memory bits, electrically erasable programmable read-only memory (EEPROM) with logically enforced memory bits, and erasable programmable read-only memory (EPROM) bits, among others. Examples of the present disclosure can utilize hardware logic to detect inconsistencies within a bit array to further reduce security threats to address potential hardware misreads of the arrays or attacks using temporal glitching, for instance.

The device 100 may provide validation of bits of an array, for instance OTP bits of an array, being properly read. This validation can occur by hardware logic of the device 100 detecting inconsistencies in configurations between portions of the array. This can provide a foundation for desired operation of security feature enablement from bits (e.g., OTP bits) by adding additional hardware logic to validate booting from read-only memory (ROM). In such an example, JTag can be disabled and a bus (e.g., I2C bus) can be disabled when in production mode. In some examples, production mode may be indicated by a set of additional bits. This validation can address a situation when an attacker is attempting to manipulate one bit at a time by preventing the attacker from finding a security hole. Additionally, the validation can complicate a glitch attack by encompassing a plurality of bits that may require manipulation in combination.

Inconsistencies detected by the device 100 (e.g., using hardware logic) can include bits of an array being inconsistent from read to read, a microprocessor debug application being dosed but a security microprocessor debug being open, a frequency monitor being out of specification (e.g., above/below a threshold), the device 100 or other device temperature being out of specification (e.g., above/below a threshold), initial code word being all 1s or 0s, among others. Examples of the present disclosure can detect such inconsistencies and place the device 100 in a most secure mode to reduce security threats.

For instance, a non-limiting example can include a portion or portions of bits within an array controlling debug security of the device 100. This portion or portions of bits can control if JTag is enabled or if register snooping is allowed. The portion or portions of bits conform to a consistent security setting such that they present a desired security combination (e.g., a cohesive security framework). The bits may be the same or different, as long as they conform to the consistent security setting allowing for integrity among security controls. Should the device 100 detect an inconsistency in the security settings between the portion or portions of bits, the device 100 can be placed in a most secure mode.

In another non-limiting example, particular bits or portions of bits can be scattered throughout the array. For instance, the bits may be debug or production bits. Hardware logic can determine whether the bits within the scattered portions are consistent (e.g., all debug or all production), and if not, the device 100 can be placed in a secure mode. While two example bit configuration settings are described herein, more than two configurations may be considered when detecting inconsistencies within the array (e.g., debug, restricted debug, production, etc.).

In yet another non-limiting example, bits can be scattered in various portions of the array. During boot, each portion of the array is read sequentially. Without the scattering of the bits, an attacker may be able to utilize a temporal glitch to change the device 100 from a secure production mode to a debug mode, resulting in a security threat. However, when the hardware logic detects an inconsistency among the portions of scattered bits, the device 100 can be forced into a most secure mode, reducing the security threat.

In some examples, additional protection methods can be combined with scattering of bits and/or re-ordering of data to reduce security threats. For instance, protections methods can include data and reverse ordered data, data and complement of the data, data and byte swapped data, and data and an algorithmic permutation of the data, among others.

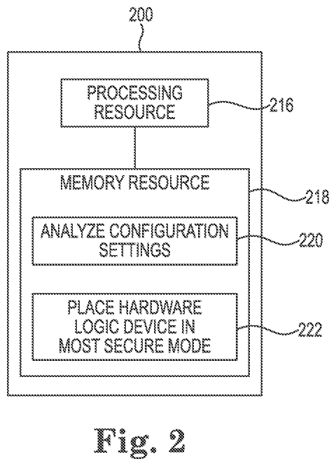

FIG. 2 illustrates another device 200 to be placed in a secure mode according to an example. FIG. 2 illustrates an example of a memory resource 218 and hardware logic 220, 222 for placing a device in a secure mode. In some examples, the memory resource 218 can include executable instructions. The memory resource 218 can be a part of a computing device 200 or controller that can be communicatively coupled to a system. For example, the memory resource 218 can be part of a device 100 as referenced in FIG. 1. In some examples, the memory resource 218 can be communicatively coupled to a processing resource 216, and the hardware logic can cause the processing resource 216 to perform a function and/or execute instructions stored on the memory resource 218. For example, the memory resource 218 can be communicatively coupled to the processing resource 216 through a communication path. In some examples, a communication path can include a wired or wireless connection that can allow communication between devices and/or components within a device or system.

The memory resource 218 may be electronic, magnetic, optical, or other physical storage device that stores executable instructions. Thus, a non-transitory machine-readable medium (MRM) (e.g., a memory resource 218) may be, for example, a non-transitory MRM comprising Random-Access Memory (RAM), read-only memory (ROM), an Electrically-Erasable Programmable ROM (EEPROM), a storage drive, an optical disc, and the like. The non-transitory machine-readable medium (e.g., a memory resource 218) may be disposed within a controller and/or computing device. In this example, the executable instructions can be “installed” on the device. In some examples, the non-transitory machine-readable medium (e.g., a memory resource) can be a portable, external or remote storage medium, for example, that allows a computing system to download the instructions from the portable/external/remote storage medium. In this situation, the executable instructions may be part of an “installation package”. As described herein, the non-transitory machine-readable medium (e.g., a memory resource 218) can be encoded with executable instructions for performing calculations or computing processes.

The device 200 can utilize hardware logic to scatter bits in various portions of an array to reduce a likelihood of a temporal glitch or other attack successfully threatening the security of the device 200 or accessing an associated secure processing resource. For instance, the hardware logic 220 can analyze a plurality of configuration settings associated with a non-volatile storage bit array (e.g., an OTP fuse bit array) controlling access to hardware logic device such as an application-specific integrated circuit (ASIC) device. The configuration settings, for instance, can include a production configuration, a debug configuration, or other security configuration associated with the device 200. To analyze the plurality of configuration settings, the hardware logic 220 can scatter portions of bits of the non-volatile storage bit array in different locations of the array. For instance, the portions of bits can be scattered in different portions of the array. The bits may be scattered among a plurality of portions of the array, in some examples.

The hardware logic can determine whether a first portion of the scattered portions of bits is in a different configuration than a second portion of the scattered portions of bits. For instance, the first portion may include bits in a first configuration and may be in a first portion of the array. The second portion may include bits in a second, different configuration and may be in a second portion of the array. By scattering the bits, the ability for an attacker to hack an array-read with precision is reduced because multiple scattered locations would need to be attacked during the sequential read.

For instance, the hardware logic can determine the first portion of bits is in the different configuration than the second portion of bits, detect the different configurations as the inconsistency, and place the hardware logic device in a most secure mode. For example, the hardware logic may determine the first portion of bits is in the production configuration and the second portion of bits is in the debug configuration (or vice versa), detect the determined configuration difference as the inconsistency, and place the hardware logic device in the most secure mode. Configurations other than production and debug configurations may be analyzed, and more than two configurations may be present, in some instances.

In some examples, the hardware logic may determine the inconsistency is a lack of a desired security combination among the scattered bits. For instance, if the first portion of bits (e.g., in a first portion of the array) has a security setting that is not consistent with the second portion of bits, the hardware logic can detect this as an inconsistency. To be consistent, the bits may not have identical security configurations, but the respective security configurations present a desired security combination. Put another way, the inconsistency includes the bit array having a security combination outside of a particular reasonableness threshold. The particular reasonableness threshold can include allowed configurations, numbers of configurations, combinations of configurations, etc., among others.

In some examples, the hardware logic may determine the inconsistency is a temporal glitch attempting to unlock a hardware feature associated with the apparatus and may restrict the glitch by requiring a threshold number of bits of the of the non-volatile storage bit array to be manipulated in combination to unlock the hardware feature. In some instances, the threshold number may be one bit manipulated, while other examples include a plurality of bits manipulated in combination to trigger a detection of an inconsistency. Consistency, in some examples, may not include all bits being the same (e.g., all 1s or all 0s), but rather that a desired logical combinations of bit values is present.

The hardware logic 222 can place the hardware logic device in a most secure mode to resist a security threat in response to detecting an inconsistency in the configuration settings during analysis. For example, the hardware logic device can be placed in a most secure mode (e.g., a production mode) when inconsistencies among the scattered bits (e.g., configuration settings scattered across portions of the array), including redundant scattered bits, are detected, This can reduce (e.g., prevent) access to the hardware logic device and/or an associated secure processing resource.

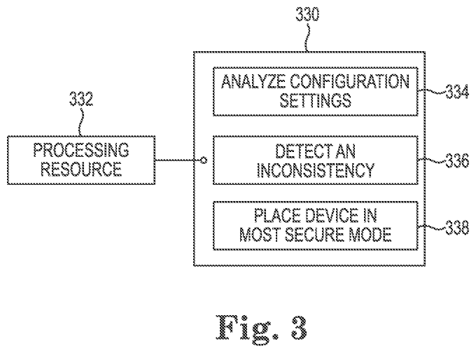

FIG. 3 illustrates yet another device to be placed in a secure mode according to an example. In some examples, the device can be a computing device, hardware logic device, or controller that includes a processing resource 332 that may be communicatively coupled to a memory resource 330. The device, in some examples, may be analogous to devices 100 and/or 200 described with respect to FIGS. 1 and 2, the processing resource 332 may be analogous to the processing resource 216 with respect to FIG. 2, and the memory resource 330 may be analogous to the memory resource 218 described with respect to FIG. 2. As described herein, the memory resource 330 can include hardware logic 334, 336, 338 to cause the processing resource 332 to perform particular functions or can store instructions that can be executed by the processing resource 332 to perform particular functions.

In some examples, the device can include hardware logic 334 to cause the processing resource 332 to analyze a plurality of configuration settings associated with a non-volatile storage array (e.g., an OTP fuse bit array) controlling access to a hardware logic device such as an ASIC device. The array can include a plurality of bits scattered among different portions of the array. Put another way, the non-volatile storage array can include a first plurality of bits scattered among a second plurality of bits (e.g., the overall array, unscattered portions, etc.).

The device can include hardware logic 336 to cause the processing resource 332 to detect an inconsistency in the configuration settings during analysis including a difference in a configuration of a first portion of the first plurality of scattered bits and a second portion of the first plurality of scattered bits. The difference in configuration, for instance, can include a difference between scattered bits such as some being in a production configuration, while others are in a debug configuration. Other examples can include configurations among different scattered bits that do not result in a cohesive or desired security setting. Yet other examples can include configurations manipulated by glitches (e.g., temporal glitches).

The first plurality of bits, in some instances, controls access to features requiring higher security levels than the second plurality of bits. For instance, the scattered bits may be chosen for their control abilities and potential targeting. In some examples, the first plurality of bits can be scattered among the second plurality of bits such that when the array is read sequentially, a glitch attack becomes more challenging. For instance, an attacker attempting to glitch the array based on an expectation of a sequential reading of the array, may not be able to glitch the array because the scattering of the bits has taken away predictable array patterns.

In some examples, the device can include hardware logic 338 to cause the processing resource 332 to place the hardware logic device in a most secure mode (e.g., a production mode) to resist a security threat in response to the detected inconsistency. In such an example, each bit of the first plurality of bits and each bit of the second plurality of bits (e.g., all bits in the array) is placed in the most secure mode. The inconsistency, in some instances, can be communicated to a secure processing resource (e.g., secure processing resource 102) in communication with the hardware logic device. For instance, upon detection of the inconsistency, the secure processing resource is alerted that access has been attempted. In some examples, the secure processing resource may confirm to the hardware logic device to go into a most secure mode, or the secure processing resource may indicate that the inconsistency was expected and to delay or cancel the placement into the most secure mode.

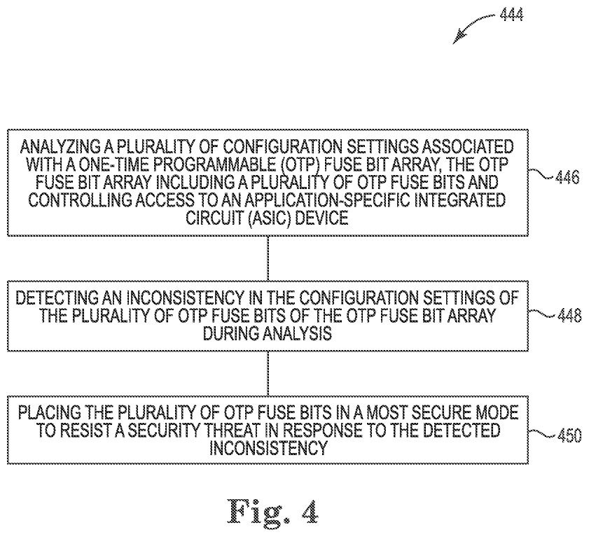

FIG. 4 illustrates an example of a method 444 for placing a device in a secure mode according to an example. The method 444 may be performed by a computing device 100, 200, hardware logic device, and/or controller as described with respect to FIGS. 1, 2, and 3. In some examples, the method 444 can be performed by instructions executable to cause a computing device to perform particular functions or by hardware logic.

The method 444, at 446, includes analyzing a plurality of configuration settings associated with an OTP fuse bit array, the OTP fuse bit array including a plurality of OTP fuse bits and controlling access to an application-specific integrated circuit (ASIC) device. At 448, the method 444 includes detecting an inconsistency in the configuration settings of the plurality of OTP fuse bits of the OTP fuse bit array during analysis. For instance, the inconsistency can be detected as a security control integrity level associated with the plurality of OTP fuse bits falling below a particular threshold. In such an example, OTP fuse bits may be scattered among different portions of the OTP fuse bit array. The scattered OTP fuse bits maintain a particular threshold security control integrity level. When that integrity level drops (e.g., a security configuration of a bit or bits changes), an inconsistency is detected.

In some instances, detecting the inconsistency can include detecting an attempt to change the configuration of one of the plurality of OTP fuse bits to a different configuration. For example, if OTP fuse bits in a first portion of the OTP fuse bit array have a debug configuration, while OTP fuse bits in a different portion of the OTP fuse bit array a production configuration, an inconsistency may be detected. In some instance, this attempt to change can present as a temporal glitch.

At 450, the method 444 includes placing the plurality of OTP fuse bits in a most secure mode to resist a security threat in response to the detected inconsistency. By placing the plurality of OTP fuse bits in a most secure mode, security threats to the ASIC device and an associated secure processing resource can be reduced. In some examples, the ASIC device can be placed in the most secure mode, and/or communication between the OTP fuse bit array and a secure processing resource of the ASIC device can be restricted.

In some examples, the plurality of configuration settings can be analyzed while running additional OTP array security threat protection. For instance, inconsistencies may be detected while other security threat protection is also being utilized. While OTP fuse bits and an ASIC device are described with respect to FIG. 4, other non-volatile storage bits and/or hardware logic devices may be utilized.

The figures herein follow a numbering convention in which the first digit corresponds to the drawing figure number and the remaining digits identify an element or component in the drawing. For example, reference numeral 00 may refer to element 100 in FIG. 1 and an analogous element may be identified by reference numeral 200 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples, and data provide a description of the system and method of the disclosure. Since many examples can be made without departing from the spirit and scope of the system and method of the disclosure, this specification merely sets forth some of the many possible example configurations and implementations.

What is claimed is:

1. An apparatus, comprising:
a memory resource; and
hardware logic to:
analyze a plurality of configuration settings associated with a non-volatile storage bit array controlling access to a hardware logic device; and
in response to detecting an inconsistency in the configuration settings during analysis, place the hardware logic device in a most secure mode to resist a security threat.

2. The apparatus of claim 1, further comprising the hardware logic to scatter portions of bits of the non-volatile storage bit array in different locations of the array.

3. The apparatus of claim 2, wherein the hardware logic is to determine whether a first portion of the scattered portions of bits is in a different configuration than a second portion of the scattered portions of bits.

4. The apparatus of claim 3, further comprising the hardware logic to:
determine the first portion of bits is in the different configuration than the second portion of bits;
detect the different configuration as the inconsistency; and
place the hardware logic device in the most secure mode.

5. The apparatus of claim 2, further comprising the hardware logic to determine whether the first portion of bits is in a production configuration and the second portion of bits is in a debug configuration or the first portion of bits is in the debug configuration and the second portion of bits is in the production configuration.

6. The apparatus of claim 5, further comprising the hardware logic to:
determine the first portion of bits is in the production configuration and the second portion of bits is in the debug configuration, or the first portion of bits is in the debug configuration and the second portion of bits is in the production configuration;
detect the determined configuration difference as the inconsistency; and
place the hardware logic device in the most secure mode.

7. The apparatus of claim 1, further comprising the hardware logic to:
determine the inconsistency is a temporal glitch attempting to unlock a hardware feature associated with the apparatus; and
restrict the glitch by requiring a threshold number of bits of the non-volatile storage bit array to be manipulated in combination to unlock the hardware feature.

8. The apparatus of claim 1, wherein the inconsistency comprises the bit array having a security combination outside of a particular reasonableness threshold.

9. A computing device, comprising:
a processing resource; and
hardware logic to cause the processing resource to:
analyze a plurality of configuration settings associated with a non-volatile storage array controlling access to a hardware logic device,
wherein the non-volatile storage array includes a first plurality of bits scattered among a second plurality of bits;
detect an inconsistency in the configuration settings during analysis including a difference in a configuration of a first portion of the first plurality of scattered bits and a second portion of the first plurality of scattered bits; and
in response to the detected inconsistency, place the hardware logic device in a most secure mode to resist a security threat.

10. The computing device of claim 9, wherein the most secure mode is a production configuration state.

11. The computing device of claim 9, wherein the first plurality of bits controls access to features requiring higher security levels than the second plurality of bits.

12. The computing device of claim 9, wherein the wherein the difference in the configuration comprises a lack of a desired logical combinations of bit values.

13. The computing device of claim 9, further comprising the hardware logic to place the hardware logic device in a most secure mode by placing each bit of the first plurality of bits and each bit of the second plurality of bits in the most secure mode.

14. The computing device of claim 9, further comprising the hardware logic to cause the hardware logic device to communicate the detected inconsistency to a secure processing resource in communication with the hardware logic device.

15. A method, comprising:
analyzing a plurality of configuration settings associated with a one-time programmable (OTP) fuse bit array, the OTP fuse bit array including a plurality of OTP fuse bits and controlling access to an application-specific integrated circuit (ASIC) device;
detecting an inconsistency in the configuration settings of the plurality of OTP fuse bits of the OTP fuse bit array during analysis; and
in response to the detected inconsistency, placing the plurality of OTP fuse bits in a most secure mode to resist a security threat.

16. The method of claim 15, further comprising placing the ASIC device in the most secure mode.

17. The method of claim 15, wherein detecting the inconsistency comprises detecting the inconsistency as a security control integrity level associated with the plurality of OTP fuse bits falling below a particular threshold.

18. The method of claim 15, wherein detecting the inconsistency comprises detecting an attempt to change the configuration of one of the plurality of OTP bits to a different configuration.

19. The method of claim 15, further comprising analyzing the plurality of configuration settings while running additional OTP array security threat protection.

20. The method of claim 15, further comprising restricting communication with the OTP fuse bit array to a secure processing resource of the ASIC device.
